(19) United States
(12) Patent Application Publication
(10) Pub. No.: US 2015/0202825 A1
(43) Pub. Date: Jul. 23, 2015

(54) Three Dimensional Printing Method

(71) Applicant: Christopher Cordingley, Los Angeles, CA (US)

(72) Inventor: Christopher Cordingley, Los Angeles, CA (US)

(21) Appl. No.: 14/596,647

(22) Filed: Jan. 14, 2015

Related U.S. Application Data
(60) Provisional application No. 61/928,794, filed on Jan. 17, 2014.

(51) Int. Cl. B29C 67/00

(52) U.S. Cl. CPC B29C 67/0055; B29L 2015/003

(57) ABSTRACT

A method of forming, in a single three dimensional printing operation, one or more parts which are to be in mutual abutment and to be relatively movable relative to one another in a final assembly. The method includes printing, simultaneously with the desired one or more relatively movable parts, additional components which support the closely abutting, mutually movable parts apart from one another during the three dimensional printing operation. The additional components may then be removed from the newly printed assembly so that the mutually movable parts can be joined in a desired closely abutting assembly wherein the mutually movable parts can move as intended. The additional support components may hold the mutually movable parts in close proximity to their final positions in the final assembly such that each of the mutually movable parts is moved into the final assembly in a straight motion parallel to every other straight motion.

### CROSS-REFERENCE TO RELATED APPLICATION

This application is a Non-Provision Utility Application and claims the benefit of the filing date of U.S. Provisional Application Ser. No. 61/928,794 filed on Jan. 17, 2014, the contents of which are incorporated herein by reference.

### FIELD OF THE INVENTION

The present invention relates to manufacturing objects by three dimensional printing, and more particularly, to a method of simultaneously printing one or more parts which in the final assembly abut one another and are mutually movable, the method avoiding the parts being fused to each other while enabling assembly of the parts immediately upon completion of the three dimensional printing process.

### BACKGROUND OF THE INVENTION

The advent of three dimensional printing as a manufacturing technique now enables precision formation of small parts. In theory, intimately interacting parts, such as gears of a gear train, can be formed to net shape in their final assembled positions by three dimensional printing to form an operable system of interacting gears. In practice, this becomes impossible because at certain scales of size, limits to resolution of the three dimensional printing process would cause the parts to be fused together during the three dimensional printing process. The result would likely be one large, monolithic assembly of mutually immovable parts. There exists a need in the art to overcome this limitation of resolution in three dimensional printing.

### SUMMARY OF THE INVENTION

The present invention addresses the above stated situation by providing a method of forming, in a single three dimensional printing operation, one or more parts which are to be in mutual abutment and to be relatively movable relative to one another in a final assembly. To this end, the invention contemplates printing, simultaneously with the desired one or more relatively movable parts, additional components which support the closely abutting, mutually movable parts apart from one another during the three dimensional printing operation. With the mutually movable parts separated from one another, the three dimensional printing process may be successfully conducted. The additional components may then be removed from the newly printed assembly so that the mutually movable parts can be joined in a desired closely abutting assembly wherein the mutually movable parts can move as intended.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a plan view of an assembly of abutting, mutually rotatable gears.

FIG. 2 is a perspective view of a frame on which the assembly of FIG. 1 is to be mounted.

FIG. 3 is an exploded perspective detail view of the gears of FIG. 1 spaced apart from their associated axles.

FIG. 4 is a side view of FIG. 3, also showing the frame of FIG. 2.

FIG. 5 is a bottom perspective view of the gears of FIG. 1 held in position by a support.

FIG. 6 is a top perspective view of FIG. 5.

FIG. 7 is a plan view of a final assembly wherein the gears of FIG. 1 are mounted on the frame of FIG. 2.

FIG. 8 is a block diagram summarizing steps of a method of fabricating the assembly of FIG. 7.

### DETAILED DESCRIPTION

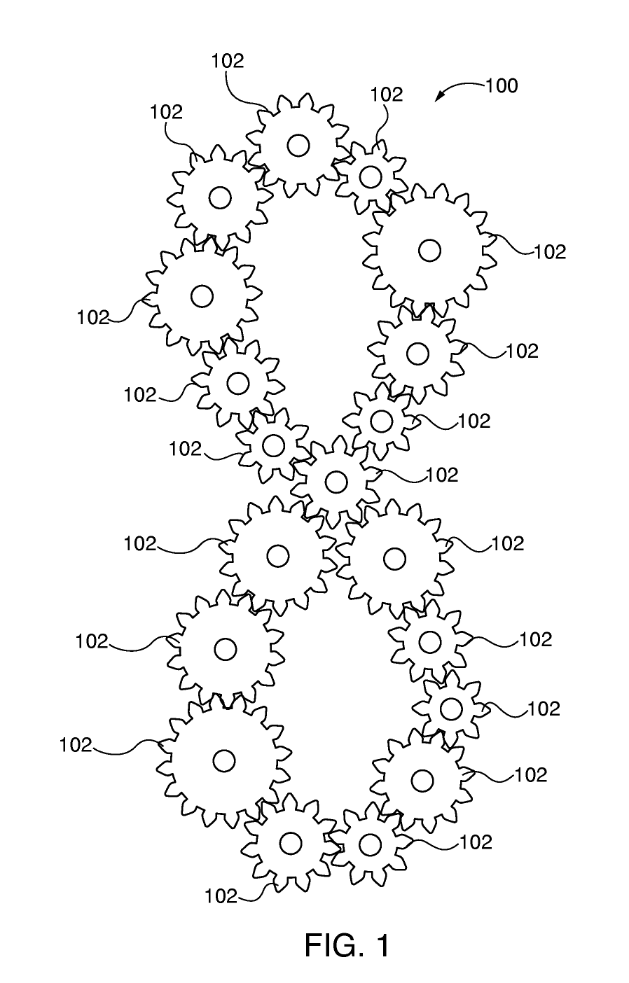

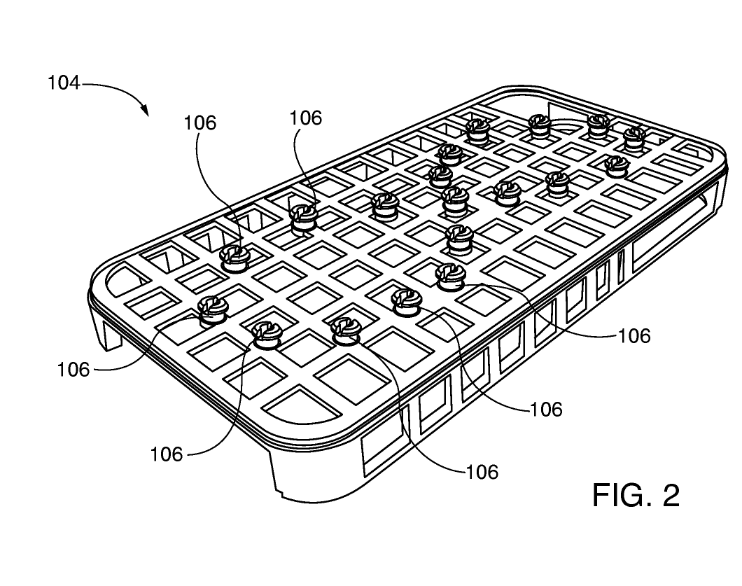

Referring first to FIG. 1, according to at least one aspect of the invention, there is shown an array 100 of abutting, mutually rotatable gears 102. FIG. 2 shows a frame 104 on which are mounted one or more axles 106. Each gear 102 is, in the final intended assembly 109 (see FIG. 7), to be mounted on one axle 106 such that the gears 102 will assume a configuration exemplified by the array 100. In the final intended assembly, the gears 102 are arranged on the axles 106 in the “figure-8” array depicted in FIG. 1. Each gear 102 will be able to rotate on its associated axle 106, and will be able to mesh with at least two abutting gears 102 as the gears 102 rotate on their associated axles 106. It would be impossible to manufacture the gears 102 in the desired “figure-8” array 100 by three dimensional printing in a conventional way because, since they abut one another, the gears 102 would be fused together in the three dimensional printing process.

In one implementation of the invention, there is set forth a method of forming the intended final assembly wherein the gears are three dimensionally printed simultaneously and held in a slightly spaced apart or expanded assembly wherein, for final assembly to the frame 104, the gears 102 are mutually positioned as the array 100 (FIG. 1) which can be positioned over the frame 104 with each individual gear 102 centered vertically over its associated axle 106.

It should be noted at this point that orientational terms such as over, down, and below refer to the subject drawing as viewed by an observer. The drawing figures depict their subject matter in orientations of normal use, which could obviously change with changes in the way the depicted subject matter could be held by a person performing manufacturing or assembly, for example. Therefore, orientational terms must be understood to provide semantic basis for purposes of description only, and not in a limiting capacity.

The individual gears 102 can then be assembled to the frame 104 by dropping each gear straight down, into engagement with its associated axle 106 below, and pressed onto the associated axle 106 into a final, operable position in which the gear 102 is supported on and can rotate about the associated axle 106.

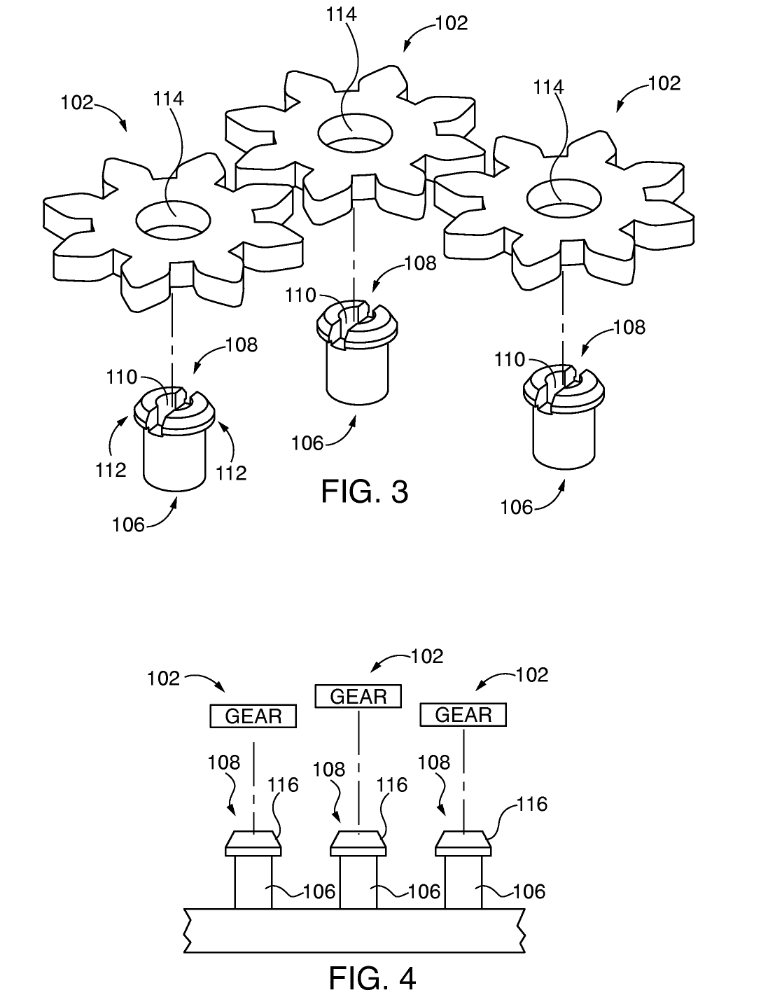

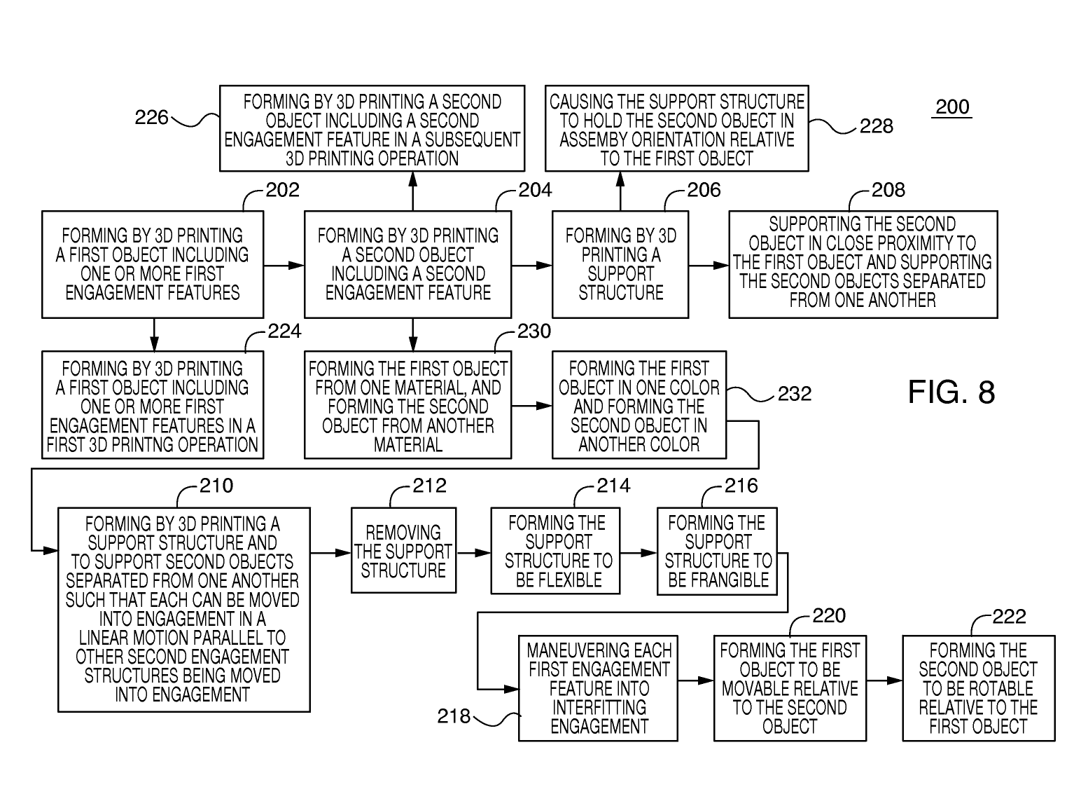

This result is achieved by a method 200 of forming an assembly by three dimensional printing, which in its most developed conception includes the following steps which are summarized in FIG. 8. The method 200 may include a step 202 of forming by three dimensional printing a first object such as the frame 104, the first object including one or more first engagement features such as the axles 106; and a step 204 of forming by three dimensional printing one or more second objects each of which includes a second engagement feature each of which complements one of the first engagement features of the first object such that interfit of the first object to the second objects is enabled. In the example of FIGS. 1-7, the second objects are the gears 102. The first engagement features of the first object are bifurcated enlarged heads 108 (FIGS. 3 and 4) which include two mirror image sections 112 including an inclined surface 116 which accommodates insertion of the bifurcated enlarged heads 108 into corresponding holes 114 formed in each gear 102. The holes 114 of the gears 102 respectively provide the second engagement features and the second objects. The holes 114 of the gears 102 and the bifurcated enlarged heads 108 of the axles 106 complement one another to enable the interfit.

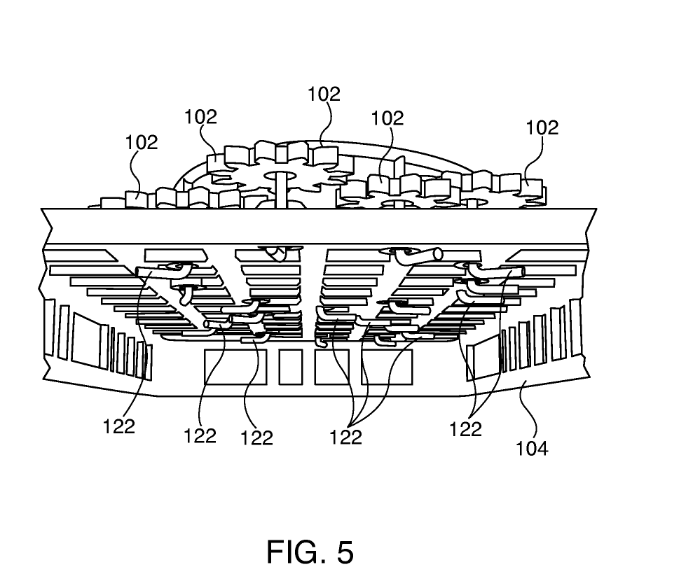

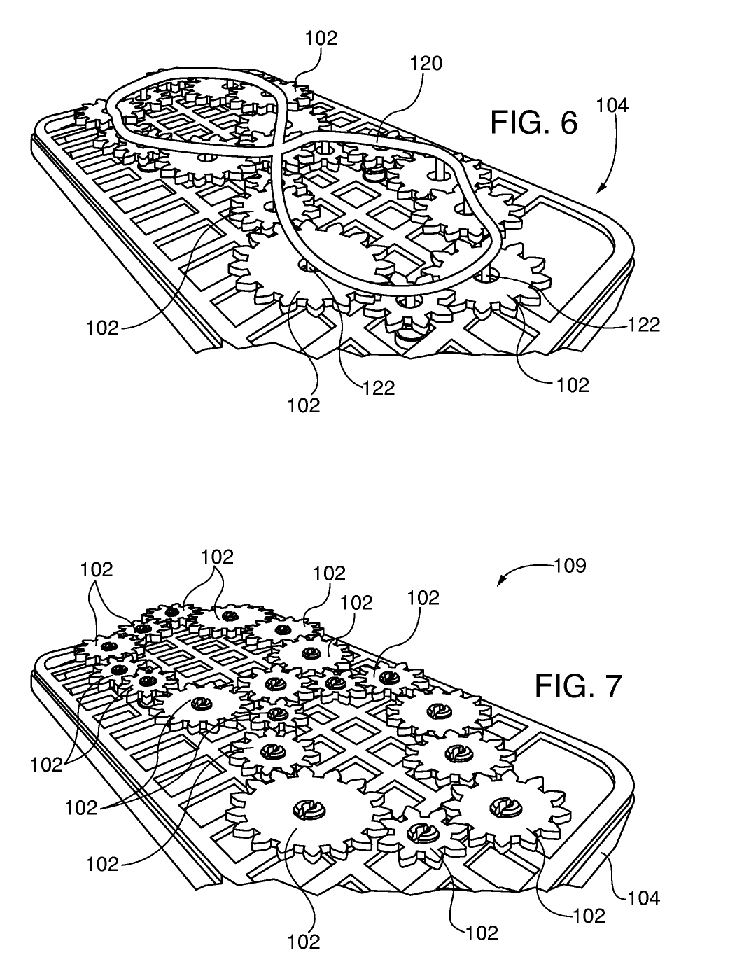

The method 200 further includes a step 206 of forming by three dimensional printing a support structure which is configured to engage the first object and to simultaneously support the second object such that the second engagement feature of the second object is supported in close proximity to the first engagement feature of the first object. In the example of FIGS. 1-7, and with particular reference to FIGS. 5 and 6, the support structure includes an upper member 120 from which depend a plurality of hooks 122. The hooks 122 pass through holes 110 (FIG. 3), each hole 110 formed in one of the gears 102. The hooks 122 hold the gears 102 immediately above their associated axles 106, but in vertically staggered positions so that each gear 102 is sufficiently separated from adjacent gears 102 so that three dimensional printing can fully form each gear 102 at the limits of resolution of the three dimensional printer (not shown) being used for fabrication. Therefore, the step 206 of the method 200 may further comprise a step 208 of supporting the second object in close proximity to the first object and supporting the second objects separated from one another such that the first object and the second object are dimensioned and configured about at the limits of resolution of a three dimensional printing apparatus.

FIG. 4 exemplifies vertically staggered positions of three gears 102, but with the support structure omitted from the view. Vertically staggered positions of several gears 102 can also be seen in FIG. 5. The gears 102 would be held proximate the frame 104, as shown in FIG. 6, by the hooks 122, which hooks 122 would pass through both the gears 102 and the axles 106, passing through the holes 110 of the axles 106. The hooks 122 terminate below the frame 104, so that the gears 102 and the frame 104 are entrapped between the upper member 120 and the hooks 122.

It should be noted that the steps 202, 204 may be performed simultaneously. That is, the frame 104 and the gears 102 may be three dimensionally printed simultaneously. Also, the steps 202 and 206 may be performed simultaneously. That is, the frame 104 and the support structure including the frame 104 and the hooks 122 may be three dimensionally printed simultaneously. Also, the steps 204 and 206 may be performed simultaneously. That is, the gears 102 and the support structure including the frame 104 and the hooks 122 may be three dimensionally printed simultaneously. Furthermore, all of the steps 202, 204, and 206 may be performed simultaneously.

The method 200 includes a step 210 of forming by three dimensional printing a support structure which is configured to engage the first object and to simultaneously support at least two of the second objects such that the second objects are separated from one another during three dimensional printing and in close proximity to the first object such that each one of the second engagement features can be moved into engagement with one of the first engagement features in a linear motion which is parallel to linear motions of every other one of the second engagement features being moved into engagement with one of the first engagement features. In the example of FIGS. 1-7, the support structure, which includes the upper member 120 and the hooks 122, engages the first object (e.g., the frame 104) and simultaneously supports the second objects (e.g., the one or more gears 104) immediately above the frame 104. The gears 102 are supported by the hooks 122 in close proximity just above and in vertical alignment with their associated axles 106. Vertical alignment is illustrated in FIG. 4 by dashed lines connecting each gear 102 to its associated axle 106. With the gears 102 supported in close proximity just above the axles 106, each gear 102 can be moved into engagement with one of the first engagement features (e.g., the enlarged head 108 of an axle 106) in a linear motion which is parallel to linear motions of every other one of the second engagement features being moved into engagement with one of the first engagement features (e.g., each gear 102 being moved straight down into engagement with an associated enlarged head of an associated axle 106).

With the gears 102 supported in vertical alignment with the axles 106 and in close proximity thereto, the gears 102 may be easily assembled to the axles 106. First, and as reflected in a step 212 of the method 200 of removing the support structure from the assembly including the frame 104, the axles 106 fixed to the frame 104, and the gears supported immediately above and in vertical alignment with the axles 106. The gears 102 are then free to drop by gravity towards their respective axles 106. This process may be performed manually. When the gears 102 contact the axles 106, each gear 102 may be maneuvered such that each bifurcated enlarged head 108 of an axle 106 penetrates a hole 114 of the gear 102.

The method 200 may include a step 214 of forming the support structure to be flexible. The hooks 122 in particular may be readily removed from the holes 110 of the axles 106 if they are flexible.

As an alternative to flexibility of the hooks 122 or of the entire support structure, the hooks or other portions of the support structure may be frangible. Therefore, even if rigid, the hooks 122 and other elements of the support structure may be removed by breaking off sections thereof. This is seen as a step 216 of the method 200, the step 216 further comprising forming the support structure to be frangible.

Bifurcation of the enlarged heads 108 of the axles 106 may generate two mirror image fingers to be defined. These mirror image fingers may display a slight degree of spring characteristics causing the enlarged heads 108 to expand within the holes 114, thereby retaining the gears 102 in engagement with their associated axles 106. The axles 106 may be sufficiently long and the enlarged heads 108 so configured that the enlarged heads 108 expand upon passing entirely through the holes 114, thereby positively entrapping the gears 102 in engagement with the axles 106.

The method 200 includes a step 218 of maneuvering each first engagement feature of the first object (e.g., each enlarged head 108 of each axle 106 mounted to the frame 104) into interfitting engagement with one second engagement feature of one second object (e.g., the hole 114 of a gear 102). The step 218 is accomplished by, for example, assembling the gears 102 to the enlarged heads 108 of the axles 106, as described hereinabove.

The method 200 includes a step 220 of forming the first object to be movable relative to the second object when the first engagement feature of the first object interfittingly engages the second engagement feature of the second object. The step 220 may further comprise a step 222 of forming the second object to be rotatable relative to the first object. Illustratively, the gears 102 may be formed at just a loose enough fit with the axles 106 so that they can rotate on the axles 106. In other examples (not shown), parts may be made which slide along one another, or which are otherwise relatively movable.

In the method 200, the step 202 of forming by three dimensional printing a first object including one or more first engagement features may comprise an optional step 224 forming by three dimensional printing a first object including one or more first engagement features in one three dimensional printing operation is performed in a first three dimensional printing operation. In this option, the step 204 of forming by three dimensional printing one or more second objects each of which includes a second engagement feature which complements one of the first engagement features of the first object such that interfit of the first object to the second objects is enabled, and the step 206 of forming by three dimensional printing a support structure which is configured to engage the first object and to simultaneously support the second object such that the second engagement feature of the second object is supported in close proximity to the first engagement feature of the first object are all performed in a single three dimensional printing operation. This is seen as optional step 226 in FIG. 8.

In the method 200, the step 206 of forming by three dimensional printing a support structure may comprise a further step 228 of causing the support structure to hold the second object in assembly orientation relative to the first object. Assembly orientation is an orientation or location of the second object relatively close to and in direct linear alignment with the first object. For example, in FIG. 4, all of the gears 102 are held directly above and in close proximity to their respective axles 106 simultaneously. In the example of FIG. 4, the gears 102 may be assembled expeditiously by pressing them onto their respective axles 106 by hand. No effort is required to locate the gears 102 since they are held in assembly orientation by the support structure. After the gears 102 are pressed into engagement with their respective axles 106, the support structure can be broken away and discarded.

Where the first and second object are made in different three dimensional printing operations, the method 200 may comprise a further step 230 of forming the first object from one material, and forming the second object from another material. The step 230 may comprise a further step 232 of forming the first object in one color, and forming the second object in another color.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of forming an assembly by three dimensional printing, the method comprising:
forming by three dimensional printing a first object including one or more first engagement features;
forming by three dimensional printing one or more second objects each of which includes a second engagement feature which complements one of the first engagement features of the first object such that interfit of the first object to the second objects is enabled; and
forming by three dimensional printing a support structure which is configured to engage the first object and to simultaneously support the second object such that the second engagement feature of the second object is supported in close proximity to the first engagement feature of the first object.

2. The method of forming an assembly by three dimensional printing of claim 1, the method further comprising removing the support structure from the assembly.

3. The method of forming an assembly by three dimensional printing of claim 1, the method further comprising maneuvering each first engagement feature of the first object into interfitting engagement with one second engagement feature of one second object.

4. The method of claim 1, wherein the steps of forming by three dimensional printing a first object including a first engagement feature, and forming by three dimensional printing a second object which includes a second engagement feature which complements the first engagement feature of the first object such that interfit of the first object to the second object is enabled are performed simultaneously.

5. The method of claim 1, wherein the steps of forming by three dimensional printing a first object including a first engagement feature and forming by three dimensional printing a support structure which is configured to engage the first object and to simultaneously support the second object such that the second engagement feature of the second object is supported in close proximity to the first engagement feature of the first object are performed simultaneously.

6. The method of claim 1, wherein the steps of forming by three dimensional printing a second object which includes a second engagement feature which complements the first engagement feature of the first object such that interfit of the first object to the second object is enabled, and forming by three dimensional printing a support structure which is configured to engage the first object and to simultaneously support the second object such that the second engagement feature of the second object is supported in close proximity to the first engagement feature of the first object are performed simultaneously.

7. The method of claim 1, wherein the steps of forming by three dimensional printing a first object including a first engagement feature, forming by three dimensional printing a second object which includes a second engagement feature which complements the first engagement feature of the first object such that interfit of the first object to the second object is enabled, and forming by three dimensional printing a support structure which is configured to engage the first object and to simultaneously support the second object such that the second engagement feature of the second object is supported in close proximity to the first engagement feature of the first object are performed simultaneously.

8. The method of claim 1, wherein the step of forming by three dimensional printing a support structure which is configured to engage the first object and to simultaneously support the second object such that the second engagement feature of the second object is supported in close proximity to the first engagement feature of the first object further comprises supporting the second object in close proximity to the first object and supporting the second objects separated from one another such that the first object and the second object are dimensioned and configured about at the limits of resolution of a three dimensional printing apparatus.

9. The method of claim 1, further comprising forming the support structure to be flexible.

10. The method of claim 1, further comprising forming the support structure to be frangible.

11. The method of claim 1, further comprising forming the first object to be movable relative to the second object when the first engagement feature of the first object interfittingly engages the second engagement feature of the second object.

12. The method of claim 11, wherein forming the second object to be movable relative to the second object comprises forming the second object to be rotatable relative to the first object.

13. The method of claim 1, wherein
forming the first object comprises forming one or more first engagement features, and
forming the second object comprises forming one or more second objects each having a second engagement feature which is interfittingly engageable with one of the first engagement features of the first object.

14. The method of claim 13, wherein simultaneously forming by three dimensional printing a support structure which is configured to engage the first object and to simultaneously support the second object at a predetermined orientation relative to the first object comprises forming by three dimensional printing the support structure which is configured to support one or more second objects spaced apart from and in close proximity to the first object such that each one of the second engagement features of each one of the second objects may be maneuvered into interfitting engagement of one of the first engagement features of the first object.

15. The method of claim 13, wherein forming one or more second objects comprises forming each one of the second objects to be movable relative to at least another one of the second objects when the second engagement features of the second objects interfittingly engage the first engagement features of the first object.

16. The method of claim 15, wherein the first object is a structural frame, and each one of the second objects is a gear.

17. The method of claim 1, wherein
forming by three dimensional printing a first object including one or more first engagement features comprises forming by three dimensional printing a first object including one or more first engagement features in one three dimensional printing operation is performed in a first three dimensional printing operation; and
forming by three dimensional printing one or more second objects each of which includes a second engagement feature which complements one of the first engagement features of the first object such that interfit of the first object to the second objects is enabled; and forming by three dimensional printing a support structure which is configured to engage the first object and to simultaneously support the second object such that the second engagement feature of the second object is supported in close proximity to the first engagement feature of the first object is performed in a subsequent three dimensional printing operation.

18. The method of claim 17, comprising the further step 230 of forming the first object from one material, and forming the second object from another material.

19. The method of claim 18, comprising the further step 232 of forming the first object in one color, and forming the second object in another color.

20. The method of claim 1, wherein forming by three dimensional printing a first object including one or more first engagement features comprises forming by three dimensional printing a first object including one or more first engagement features in one three dimensional printing operation is performed in a first three dimensional printing operation; and forming by three dimensional printing one or more second objects each of which includes a second engagement feature which complements one of the first engagement features of the first object such that interfit of the first object to the second objects is enabled; and forming by three dimensional printing a support structure which is configured to engage the first object and to simultaneously support the second object such that the second engagement feature of the second object is supported in close proximity to the first engagement feature of the first object are all performed in a single three dimensional printing operation.

21. The method of claim 1, wherein forming by three dimensional printing a support structure further comprises causing the support structure to hold the second object in assembly orientation relative to the first object.

22. A method of forming an assembly by three dimensional printing, the method comprising
forming by three dimensional printing a first object one or more first engagement features;
forming by three dimensional printing one or more second objects each of which includes a second engagement feature which complements one of the first engagement features of the first objects such that interfit of the first object to each one of the second objects is enabled; and
forming by three dimensional printing a support structure which is configured to engage the first object and to simultaneously support at least two of the second objects such that the second objects are separated from one another during three dimensional printing and in close proximity to the first object such that each one of the second engagement features can be moved into engagement with one of the first engagement features in a linear motion which is parallel to linear motions of every other one of the second engagement features being moved into engagement with one of the first engagement features.
